(19) United States
(12) Patent Application Publication
(10) Pub. No.: US 2025/0057727 A1
(43) Pub. Date: Feb. 20, 2025

(54) PRESSURE COMPENSATION DEVICE FOR RECONSTITUTION, WITHDRAWAL AND TRANSFER OF A DRUG FROM A VIAL OR OTHER VACUUM CONTAINER, AND APPARATUS COMPRISING THE ABOVE SAID DEVICE

(71) Applicant: Paolo Gobbi Frattini s.r.l., Milano (IT)

(72) Inventors: Dario CASPANI, Milano (IT); Paolo Giuseppe GOBBI FRATTINI, Sondalo (SO) (IT)

(73) Assignee: Paolo Gobbi Frattini s.r.l., Milano (IT)

(21) Appl. No.: 18/725,922

(22) PCT Filed: Sep. 26, 2022
(86) PCT No.: PCT/IB2022/059123

§ 371 Date: Jul. 1, 2024

(30) Foreign Application Priority Data
Dec. 30, 2021 (IT) 102021000033080
Apr. 27, 2022 (IT) 102022000008273

(51) Int. Cl. A61J 1/20

(52) U.S. Cl. CPC A61J 1/2072; A61J 1/201; A61J 1/2048

(57) ABSTRACT

A pressure compensation device (1) for an apparatus for the reconstitution, withdrawal and transfer of a drug from a vial or other vacuum container with a hermetic closure plug being pierceable by axial pressure comprises a three-dimensional compensation bag (2) with distinct flexible walls (3) and internal space (4) containing sterile air, which is interposed between a device (5) for hooking and piercing the closure plug of the vial (16) and a terminal connector (6) with an hermetic closure valve being openable by axial pressure applied with the luer (25) of a needless syringe (27) or with other extraction means and automatically hermetically reclosable upon ceasing pressure. The hooking and piercing device (5) comprises a hooking and retaining cowling (7), a piercing stem (11) with axial internal passage (49), and a sealing element (12).

### BACKGROUND OF THE INVENTION

The present invention relates to a pressure compensation device for an apparatus for the reconstitution, withdrawal and transfer of a drug from a vial or other vacuum container, and an apparatus comprising the aforesaid device.

In the pharmaceutical field, more or less complex apparatuses are known, which allow reconstituting, withdrawing and transferring a drug from a vial with a hermetic closure plug, which contains and stores an active drug substance under vacuum for the subsequent administration to a patient. The active drug substance can be in liquid or gel or powder form, in which case it needs to be first diluted for reconstituting the drug to be administered.

Such apparatuses are to be in closed format-particularly in the case of cytotoxic drugs—i.e., without any communication with the external environment so as to exclude a possible leakage of drug traces which can be highly hazardous for the health of the healthcare professional preparing the drug treatment for the patient.

In such closed systems, the need exists to compensate for the internal pressures of the system once the vial has been accessed by means of a hooking device with a piercing tip of the closure plug.

In apparatuses currently on the market, pressure compensation conventionally occurs by means of a filter in the vial hooking device, which allows sterile air to enter into the vial and exit therefrom towards the outside without harmful drug particles. These filter apparatuses cannot be categorized as “closed systems” because even minute traces of the drug cannot be retained by the filter, particularly in the case of contact with a liquid drug, which compromises the filtering properties thereof.

Another solution on the market includes a closed ampoule to be applied to the vial hooking device and communicating with a specific channel in the piercing tip of the hooking device.

WO 2020/221594 A1 describes a closed circuit apparatus for the transfer of hazardous pharmaceutical fluid, comprising a compensation chamber consisting of a cylindrical bellow with internal space filled with sterile air and a corrugated external wall made of elastic material, which is compressible and longitudinally extendible in an accordion-like manner. A first connector suitable for the connection to the luer of a syringe is integrally fixed at a first end of the compensation chamber. Said first connector has an axial internal passage in which a first valve is inserted, which is manually movable between an opening position and a closing position of such an internal passage. A second connector suitable for the connection to a vial or other type of hazardous liquid drug container is in turn integrally fixed at a second end of the compensation chamber, opposite to the first end. The second container ends with a needle with two coaxial longitudinal channels, suitable for the perforation of the closure plug of the vial or other drug container. A second elastic membrane-shaped valve with a small central slit is positioned between the compensation chamber and the second connector to automatically close and open the communication between the chamber and the second connector as a function of the pressure acting on the two opposite faces.

When withdrawing a drug dose from a vial containing the drug itself is required, once the first valve has been closed, the second connector is hooked to the drug vial so that the two-channel piercing needle thereof penetrates the vial closure plug. With the withdrawing device arranged with the vial at the top and the first connector with related first valve at the bottom, the bellow is axially compressed resulting in a volume reduction of the internal space thereof, as well as resulting in the transfer of sterile air from the compensation chamber to the vial, passing through the central slit of the interposed elastic membrane, which in turn is forced into the opening position, and one of the two channels of the piercing needle. Thereby, the liquid drug contained in the vial is forced to move from the vial to the compensation chamber, passing through the other channel of the piercing needle and the central slit of the elastic membrane. In essence, the pumping of the drug from the vial to the compensation chamber is performed and possibly repeated.

If not done before, the luer of a syringe is then screwed at the end of the first connector and the first valve is moved to the opening position so that a desired dose of drug can be extracted from the compensation chamber and transferred by suction to the syringe. The first valve is then closed and the syringe with the drug dose can be separated for the administration of the drug to the patient.

The device described in WO 2020/221594 A1 has certain drawbacks which the present invention aims to solve. The drawbacks are:
a) poor handling of the cylindrical bellow with corrugated wall during compression;
b) instability of the syringe plunger at the end of the withdrawal, resulting in dosing uncertainty;
c) non-automatic closing of the first connector resulting in the possibility of drug leakage from the compensation chamber due to a lack of attention or incorrect maneuver by the operator;
d) possibility of drug leakage from the syringe luer due to lack of attention or incorrect maneuver by the operator.

It is particularly apparent that drawbacks b), c) and d) can generate disastrous effects in the case of toxically hazardous drugs.

### SUMMARY OF THE INVENTION

It is the object of the present invention to provide a pressure compensation device and an apparatus with a pressure compensation device which allow reconstituting and/or withdrawing and transferring the drug contained in a vial in a closed mode, i.e., without the risk of the leakage of particles, vapor or aerosol, while ensuring maneuvering ease, absolute accuracy in dosing the withdrawn drug, and certainty of avoiding any possibility of undesired drug leakage.

According to the present invention, such an object is achieved by a pressure compensation device and an apparatus with a pressure compensation device set forth in the claims.

An important advantageous effect of the pressure compensation device according to the present invention is that, once the bag has been filled with the correct amount of sterile air, the sealing closures in the hooking and piercing device and in the syringe luer connector block any communication between the interior and exterior of the bag, thus preventing both the leakage of sterile air from the bag and the contamination of the sterile air itself with the air of the surrounding space.

To withdraw a drug in the liquid state—which is ready in the final form—from a vial, the hooking and piercing device is connected to the plug of a vial (or other type of container with a pierceable plug) and the luer of a syringe (or other extraction means) is connected to the connector, resulting in the opening of the hermetic closure valve which is openable by axial pressure.

By laterally compressing the bag wall, an amount of sterile air is forced to enter into the internal compartment of the vial, thus completely compensating for the vacuum in said internal compartment.

In order to withdraw the drug prior to or after the pressure compensation, the apparatus is placed upside down, i.e., with the vial at the top and the connector with a syringe at the bottom. By retracting the syringe plunger, a dosed amount of drug can now be sucked from the vial to the bag, and finally into the syringe.

Once the apparatus has been overturned again, the syringe can be separated from the vial to transfer the drug to a drug collection and dispensing bag or to any other device for administering the drug to the patient.

On the other hand, if the active substance contained in the vial is a powder or gel, the hooking and piercing device is connected to an underlying vial, thus piercing the closure plug, and the luer of a syringe is connected from the top to the bag connector. The pressure is then compensated for by laterally compressing the compensation bag, resulting in the transfer of sterile air into the vial. By pressing the syringe plunger, an appropriate amount of diluent is then introduced into the bag and then into the vial, to be mixed with the active substance to reconstitute the drug to be administered to the patient. After the reconstitution, a desired dose of drug can be sucked from the syringe, which after separation from the connector is ready for transferring the drug to a drug collection and dispensing bag or to any other device for administering the drug to the patient.

In both cases, there is a need to provide a clamp or other similar device which allows completely closing the internal passage of the connector when laterally compressing the bag for the pressure compensation. Without this, an undesired transfer of sterile air from the bag to the syringe which would alter the initial position of the plunger inside the syringe, and therefore the dose actually withdrawn, could occur in such a step.

It is apparent that the handling of the drug occurs within a completely closed system which ensures a condition of complete safety for the healthcare professional, while facilitating the maneuver for the operator, resulting in an execution speed increase.

It is particularly worth noting that the total compensation for the pressures along with the presence, in the terminal connector, of a hermetic closing valve which is openable by axial pressure and automatically hermetically reclosable upon ceasing said axial pressure ensures accurate dosing of the drug dose sucked into the syringe.

It is also certain that once the syringe has been separated, the unsucked drug remains in the vial or compensation bag without any possibility of leakage of pollutants and hazardous particles of the drug itself.

By applying a suitable adapter to the syringe luer, which is separably connectable to the compensation bag connecter and internally provided with a valve device which opens the internal passage thereof only upon connection to the bag connector and closes it at the end of the connection, it is also possible to be certain that no drug leakages occur once the syringe has been removed until the syringe is connected to a collection bag or administration device by means of a connector with a hermetic closure control valve similar to that of the terminal connector of the compensation bag, i.e., openable by axial pressure.

### DESCRIPTION OF THE DRAWINGS

An embodiment of the device and apparatus according to the present invention is shown by way of a non-limiting example in the accompanying drawings, in which:

FIG. 1 shows a front view of the pressure compensation device prior to hooking to a vial and the application of a syringe;

FIG. 2 shows a cross section view of the pressure compensation bag of the device apparatus in FIG. 1, according to line II-II in FIG. 1;

FIG. 3 shows a longitudinal section view of the device in FIG. 1, according to line III-III in FIG. 1;

FIG. 4 shows an exploded front view of the whole apparatus;

FIG. 5 shows the apparatus in FIG. 4 already assembled and hooked to a vial for containing the active drug substance;

FIG. 6 shows a longitudinal section view of the apparatus in FIG. 5, according to line VI-VI in FIG. 5;

FIG. 7 also shows a longitudinal section view—as in FIG. 6—of the enlarged detail of the hooking of the pressure compensation device to the vial for containing the active drug substance;

FIGS. 8 and 9 show the details of the hooking and piercing device of the vial prior to and after the hooking and piercing operation;

FIG. 10 shows an axial section view of a possible variant of the hooking and piercing device;

FIG. 11 also shows a longitudinal section view—as in FIG. 6—of the enlarged detail of the connection of a syringe with a luer adapter to the pressure compensation device connector;

FIG. 12 shows the apparatus in pre-operational condition when a drug dose is withdrawn from the vial;

FIG. 13 shows the apparatus placed upside down when withdrawing a drug dose;

FIG. 14 shows a possible use of the withdrawn drug dose.

### DETAILED DESCRIPTION OF THE INVENTION

The pressure compensation device shown in the drawings, where indicated by reference numeral 1 as a whole, comprises an elongated three-dimensional compensation bag or buffer 2 which has a laterally compressible, elastically flexible external wall 3 and an internal space 4 filled with sterile air. Bag or buffer 2 preferably has the cross section shape shown in FIG. 2, i.e., approximately rectangular with rounded corners, but the shape of the bag can vary as long as it is three-dimensional and capable of allowing the variation in volume of the internal space thereof by lateral compression to be applied to the two longest lateral sides.

Whatever the shape thereof, the compensation bag 2 has an end integrally provided with a hooking and piercing device 5 for a vial or other type of container with hermetic closure plug which can be pierced by axial pressure, and an opposite end integrally provided with a connector 6 with hermetic closure valve which is openable with axial pressure for connecting bag 2 to a syringe luer or other suction means.

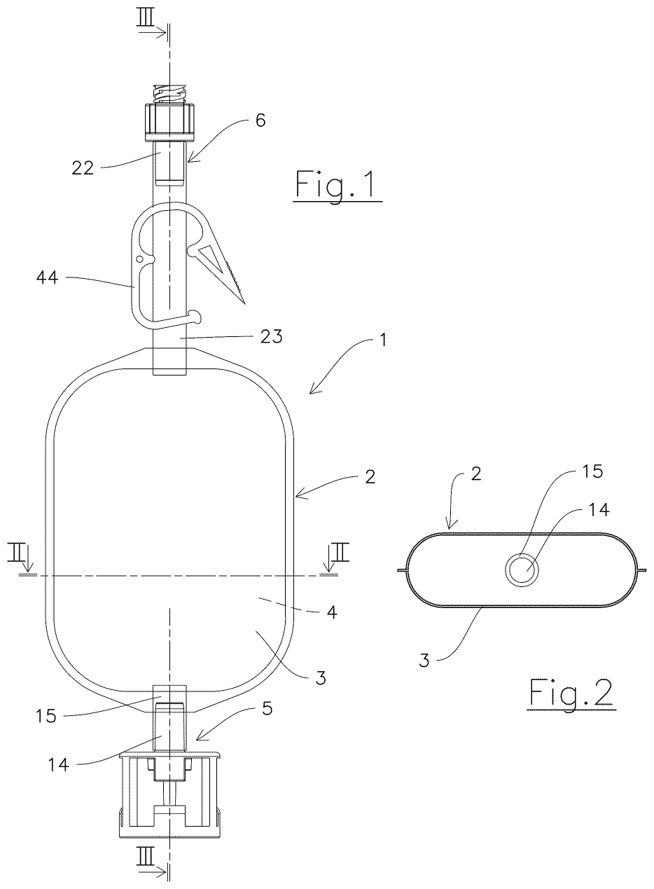

It is worth noting that the three parts 2, 5 and 6 of the pressure compensation device—shown already assembled in FIGS. 1-3—can also be provided to the uses as separate pieces that the user himself/herself will assemble and then fill with sterile air.

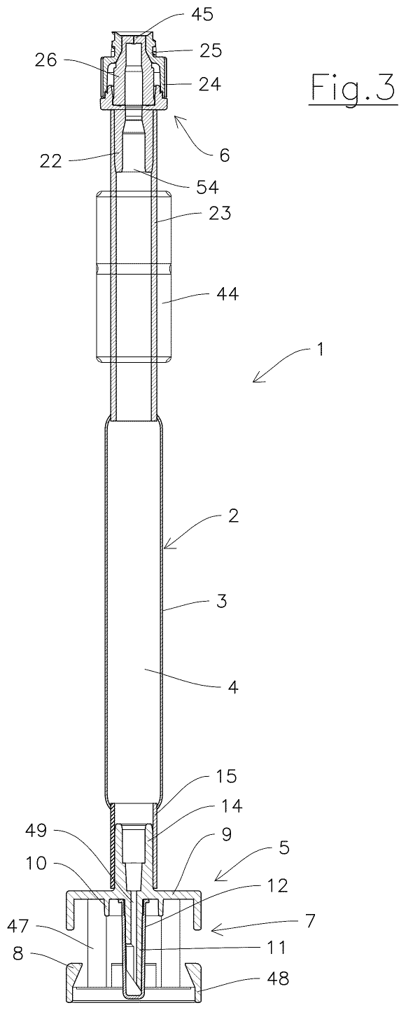

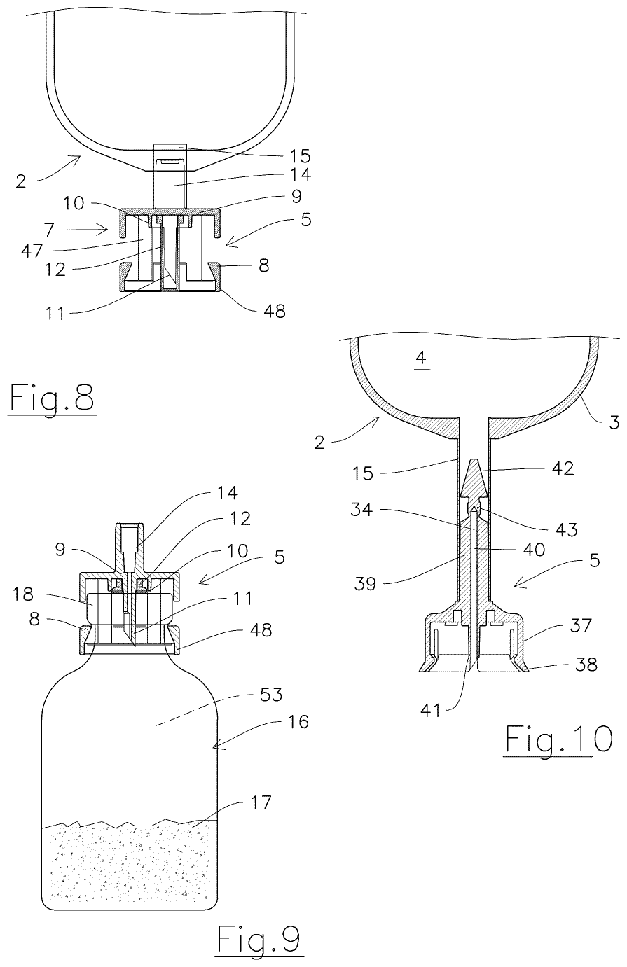

As better shown in FIGS. 3 and 8, the hooking and piercing device 5 substantially is of the type shown in EP 3144244 B1 and comprises, by way of example, a hooking part consisting of a cowling 7 with circumferentially distributed teeth 8 intended to hook and firmly retain the closure plug of a vial (or phial or other type of container), and a piercing part consisting of a pointed stem 11 with an axial hole 49, which integrally extends into cowling 7 from a flat plate 9 with annular collar 10 and on which an axially compressible tubular cap 12 is forced, ensuring the closure of the axial hole 49 of stem 11. The cowling 7 comprises a flat plate 9 with annular collar 10, which is connected by rods 47 to a terminal ring 48 from which the teeth 8 project. An axial extension 14, in turn with an axial hole 47, which is axially forced into a tube 15 integrally projecting from the compensation bag 2, extends from plate 9, in opposite direction with respect to the bored stem 11.

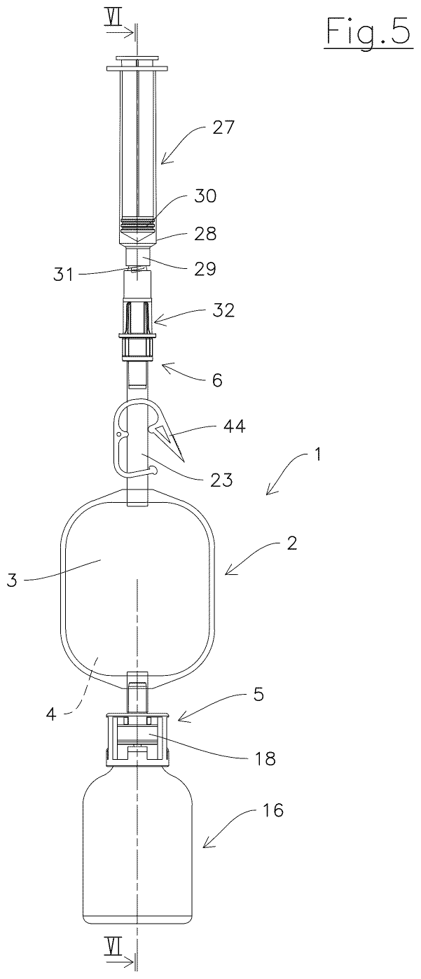

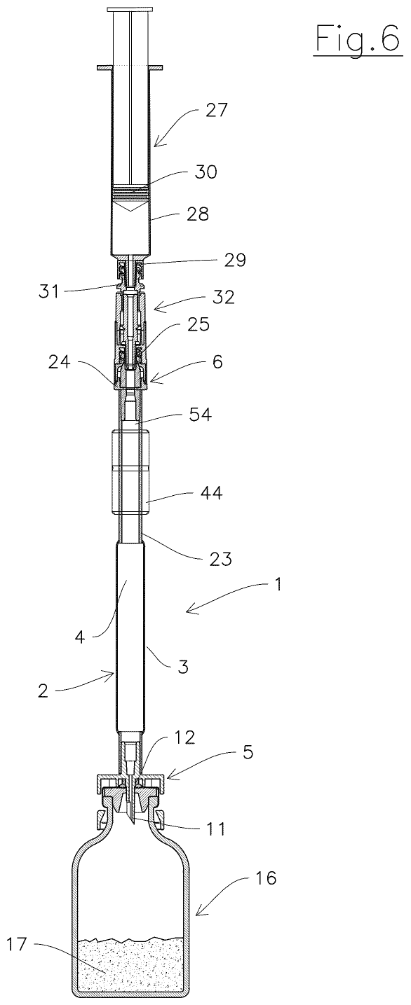

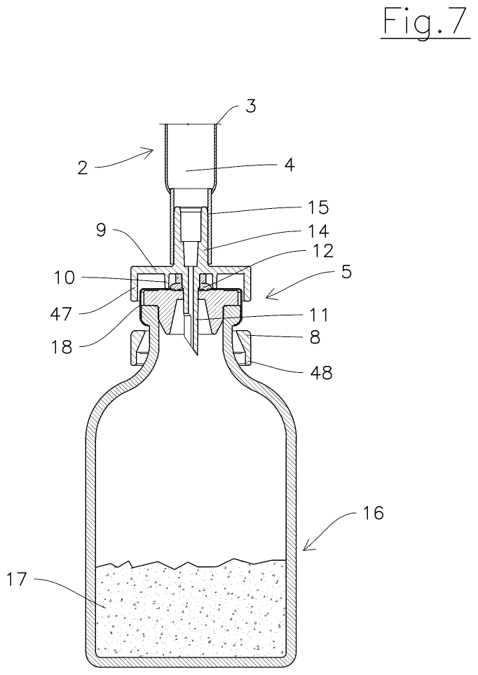

FIGS. 5-7 and 9 show the hooking and piercing device 5 applied to a vial 16 with internal compartment 53 partially filled with an active powder, gel or liquid substance 17, kept under vacuum, and provided with a hermetic closure plug 18 with a rubber middle part to be pierced by axial pressure, by way of example of the type described in EP 2 867 132 B1. The vial 16 is hooked by arranging the cowling 7 of the hooking and piercing device 5 around plug 18, with the teeth 8 in turn inserted below plug 18. The hooking results in the simultaneous piercing of plug 18 by the pointed axial stem 11 of device 5. Simultaneous to the piercing of the vial plug is the axial compression of the tubular cap 12, which once retracted, creates a retaining ring outside the upper part of stem 9 and around collar 11, which in contact with the rubber part of plug 18 causes the hermetic closure of the hooking part of device 5 against any drug leakage towards the external space. Once the hooking is complete, the teeth 8 retain vial 16 in an irremovable manner, thus preventing any possibility of release.

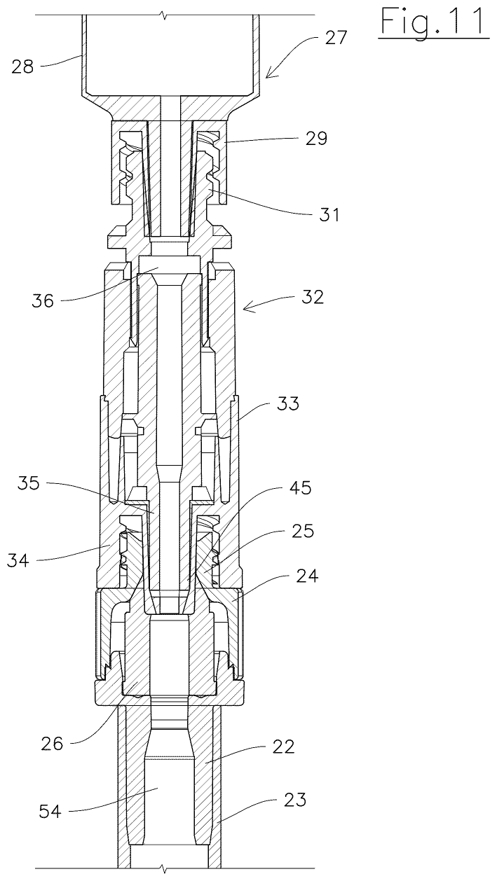

Alternatively, the hooking and piercing device 5 can be of the type shown in FIG. 10, i.e., comprising a hooking part consisting of a cowling 37 with circumferentially distributed toothed sectors 38 intended to hook the closure plug of the vial, and a connecting part consisting of a stem 39 with internal bored passage 40 which is forced into the spigot 15 integrally projecting from the compensation bag 2. The stem 39 also extends into cowling 37, where it ends with a pointed end 41, also axially bored, which is intended to pierce the closure plug of the vial. A closing element 42 with a breakable neck 43 is integrally joined at the other end of stem 39 serving the function of normally closing the communication between the internal passage 40 of stem 39 and that of spigot 15 and allowing the opening thereof by breaking the breakable neck 43.

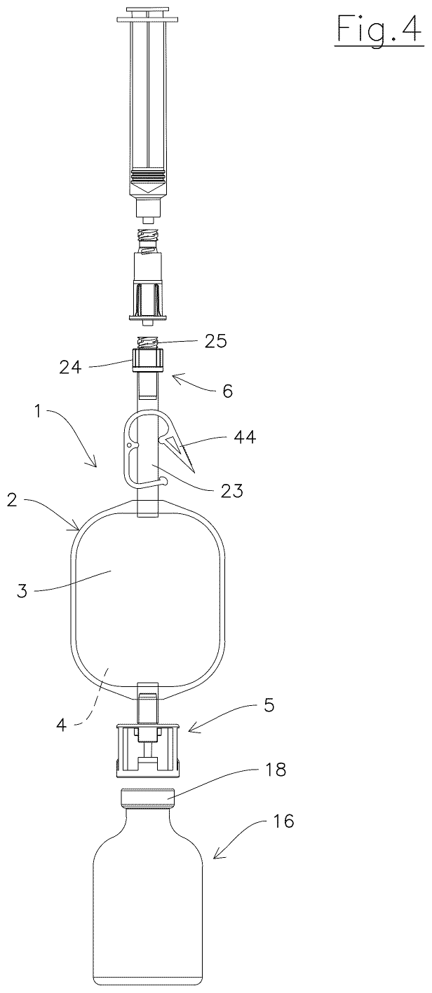

As in turn shown in FIGS. 1, 3-6 and 11, the connector 6 substantially is of the type described in EP 2 667 839 B1 and comprises, by way of example, an axially bored stem 22 which is forced into a tube 23 integrally projecting from the compensation bag 2 and longitudinally crossed by an internal passage 54 communicating with the internal space 4 of the bag. Also made integral with stem 22 is an external body 24 with threaded end 25 having a small diameter, in which an axially bored internal body 26 is housed. The latter includes a hermetic closure valve 45 which is openable by axial pressure and automatically elastically reclosable upon ceasing such an axial pressure. A manually operable clamp 44 is applied to spigot 23 for temporarily closing the internal passage of spigot 23.

FIGS. 5, 6 and 10 in turn show a syringe 27 consisting of a cylinder 28 with a threaded luer 29 and a sliding plunger 30. Connected to luer 29 is a threaded end 31 of an adapter 32 having an external body 33 with another threaded end 34 which is screwable on the threaded end 25 of connector 6 and an internal body 35 with a valve element 36 projecting out of the threaded end 34 of the external body 33 to cause the valve 45 of connector 6 to open once screwing by axial pressure is complete.

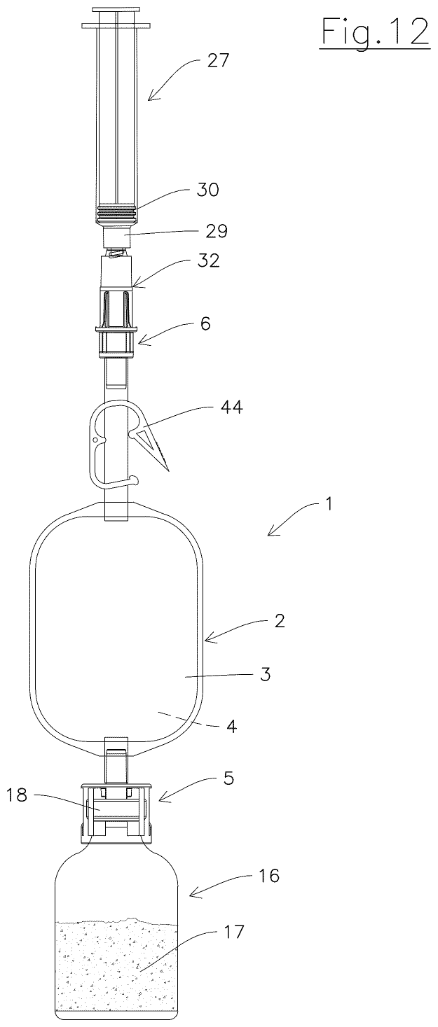

When used to withdraw an active substance 17 from a vial 16 with a closure plug 18, the pressure compensation device 1 is hooked to the vial by means of the hooking and piercing device 5 which simultaneously causes the closure plug of the vial to be pierced. A syringe 27 with an adapter 32 applied to luer 29 is then connected to the connector 6 until the valve 45 of the connector itself opens, and a fluid path between syringe 27 and bag 2 opens as well (FIG. 12).

Once the clamp has been placed in closing position, the pressure can be compensated for by laterally compressing the flexible walls of bag 2, resulting in the introduction of sterile air into the vial 16.

For a complete pressure compensation, it is essential for the amount of air initially contained in bag 2 to be equal to or greater than the volume of the part of vial not occupied by the active substance 17.

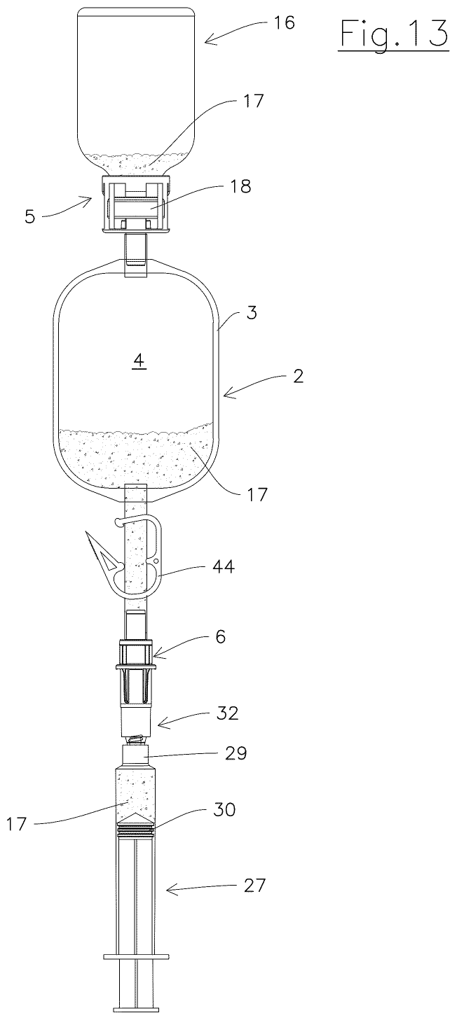

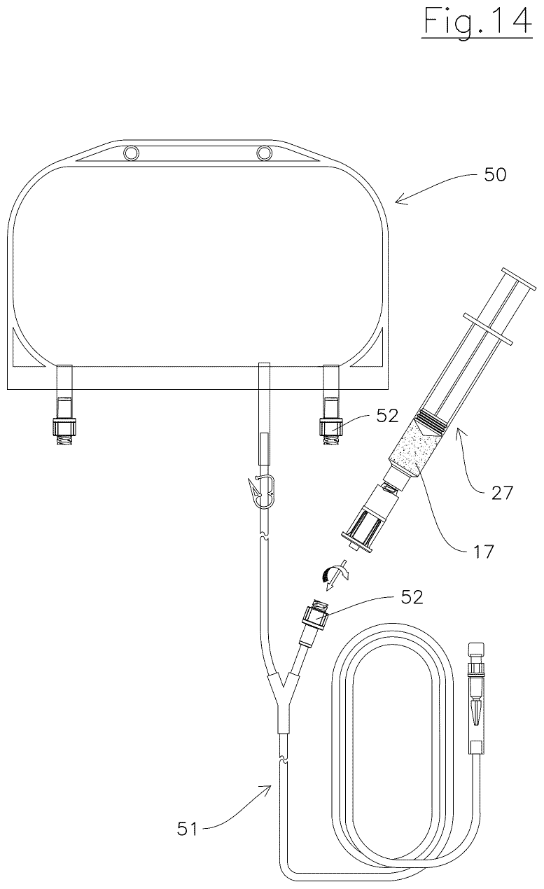

If the active substance to be withdrawn is in liquid form, the apparatus is placed in inverted position prior to or after the pressure compensation, i.e., with the vial at the top and the connector with syringe at the bottom. By retracting the syringe plunger, a dosed quantity of drug can now be sucked from the vial to the bag, and finally into the syringe, as shown in FIG. 13.

Once the apparatus is again upside down, the syringe can be separated from the vial to transfer the drug to a drug collection and dispensing bag 50 or to any other device 51 for administering the drug to the patient. The transfer occurs by connecting the syringe 27 with adapter 32 to a connector 52 which is entirely similar to the connector 6 of the compensation and withdrawal device 1.

On the other hand, if the active substance contained in the vial is a powder or gel, the hooking and piercing device 5 is connected to an underlying vial, thus piercing the closure plug, and the luer of a syringe is connected from the top to the connector 6 of bag 2. The pressure is then compensated for by laterally compressing the walls of bag 2, resulting in the transfer of sterile air into the vial. By pressing the syringe plunger, an appropriate amount of diluent is then introduced into the bag and then into the vial, to be mixed with the active substance to reconstitute the drug to be administered to the patient. After the reconstitution, a desired dose of drug can be sucked from the syringe, which after separation from the connector is ready for transferring the drug to a drug collection and dispensing bag or to any other device for administering the drug to the patient.

1. A pressure compensation device for an apparatus for the reconstitution, withdrawal and transfer of a drug from a vial wherein the vial has an internal compartment with a first part occupied by the drug and a second part not occupied by the drug, and a hermetic closure plug which is pierceable by axial pressure, wherein the pressure compensation device comprises an elastically flexible compensation bag containing sterile air, which is axially interposed between a piercing device for hooking and piercing the closure plug of the vial and a syringe luer connector, wherein the compensation bag has a laterally compressible, three-dimensional external wall and an internal space filled with an amount of sterile air which is equal to or greater than the volume of the part of an internal compartment of the vial not occupied by the drug, the syringe luer connector contains an axial passage with a hermetic closure control valve which is openable by axial pressure from outside the compensation bag and automatically hermetically reclosable upon ceasing the axial pressure, and a hooking and piercing device comprises a hooking and retaining cowling, a piercing stem with an axial internal passage, and a sealing element.

2. The pressure compensation device according to claim 1, wherein it also comprises manual means for completely closing and opening the axial passage of the syringe luer connector.

3. The pressure compensation device according to claim 1, the syringe luer connector comprises an axially bored stem which is forced into a tube integrally projecting from the compensation bag and communicating with an internal compartment thereof and with which an external body with externally threaded end is made integral, where an axially bored internal body including the hermetic closure control valve is housed.

4. The pressure compensation device according to claim 1, wherein the hooking and piercing device comprises a hooking part consisting of a cowling with teeth to hook and firmly retain the closure plug of the vial, and a piercing part consisting of the piercing stem with axial hole which extends into the cowling from a flat plate with annular collar and on which an axially compressible tubular cap is inserted, which cap when hooking the piercing device to the closure plug of the vial is axially compressed by the closure plug to form a retaining ring in the annular collar and around the piercing stem.

5. The pressure compensation device according to claim 1, wherein the hooking and piercing device comprises a hooking part consisting of a cowling with circumferentially distributed toothed sectors to hook the closure plug of the vial, and a connecting part consisting of an axially bored stem with an internal bored passage which is forced into a tube integrally projecting from the compensation bag and communicating with the internal space thereof, the axially bored stem also extending into the cowling and ending with an axially bored pointed end for piercing the closure plug of the vial.

6. An apparatus for the reconstitution, withdrawal and transfer of a drug from the vial comprising the pressure compensation device according to claim 1.

7. The apparatus according to claim 6, wherein it comprises a drug suction syringe provided with a luer to which an end of an adapter is fixable, the latter having another end being fixable to the syringe luer connector of the compensation device to open the axial passage of the syringe luer connector.
